(19) United States
(12) Patent Application Publication
(10) Pub. No.: US 2006/0149878 A1
(43) Pub. Date: Jul. 6, 2006

(54) Efficient interrupt processing in systems with multiple serial protocol engines

(76) Inventors: Richard D. Carmichael, Phoenix, AZ (US); Richard C. Beckett, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,580

(22) Filed: Dec. 30, 2004

(51) Int. Cl. G06F 13/24

(52) U.S. Cl. 710/263

(57) ABSTRACT

An apparatus and method for quickly processing latency-sensitive interrupts and for processing order-dependent interrupts in the proper order.

### TECHNICAL FIELD

The present invention relates generally to input/output controllers in a computer system and in particular, but not exclusively, to efficient interrupt processing with multiple serial protocol engines.

### BACKGROUND

FIG. 1 illustrates details of an input/output (I/O) controller 106. The controller 106 includes a host interface 102 that allows the I/O controller to communicate with the host processor of a computer system in which the I/O controller is located. The host interface 102 is coupled to a local I/O processor and to a memory 104 via a main bus 110. The main bus 110 also couples the host interface, the I/O processor and the memory 104 to one or more protocol engines 108₀ through 108_{N}. The protocol engines 108₀ through 108_{N} serve as the interface between the I/O controller 106 external devices, in this case storage devices 114₀ through 114_{N}.

Each I/O device 114 connected to the controller 100 requires intermittent servicing by the I/O processor 106 to ensure proper operation. Services may include data transmission, data capture and/or any other data manipulating operations essential to the functionality of the I/O devices. Each I/O device may have a different servicing schedule that is defined by the type of I/O device and its current condition. The host processor 102 is required to service these I/O devices in accordance with their individual needs while running one or more background programs. During operation of the I/O controller 106, a large number of interrupts may be generated by the interaction of each protocol engine 108 with its respective external device 108. When an interrupt occurs, it is written into an interrupt register 112 within each of the protocol engines 108, where the interrupt waits until it can be serviced by the I/O processor.

A problem arises with this arrangement, however, when the interrupts stores in the registers are sensitive to latency. To access the interrupts stored in the interrupt registers 112, the I/O processor 106 must first access the bus 110, then access the protocol engine, and then the interrupt register. The number of required accesses, coupled with the fact that the bus 110 tends to run at substantially slower speeds that the communication speed between, means that the I/O processor may not be able to cope with the number of interrupts being generated in the protocol engines 108. A related problem arises with a special class of interrupts from the analog front-end (not shown in FIG. 1) of each protocol engine. These interrupts require the processor to understand the sequence order of interrupt status causing events, meaning that the processor 106 needs to service all interrupts quickly enough to always determine the sequence of interrupts. With numerous protocol engines running concurrently this is not practical, if at all possible.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic drawing of an input/output controller.

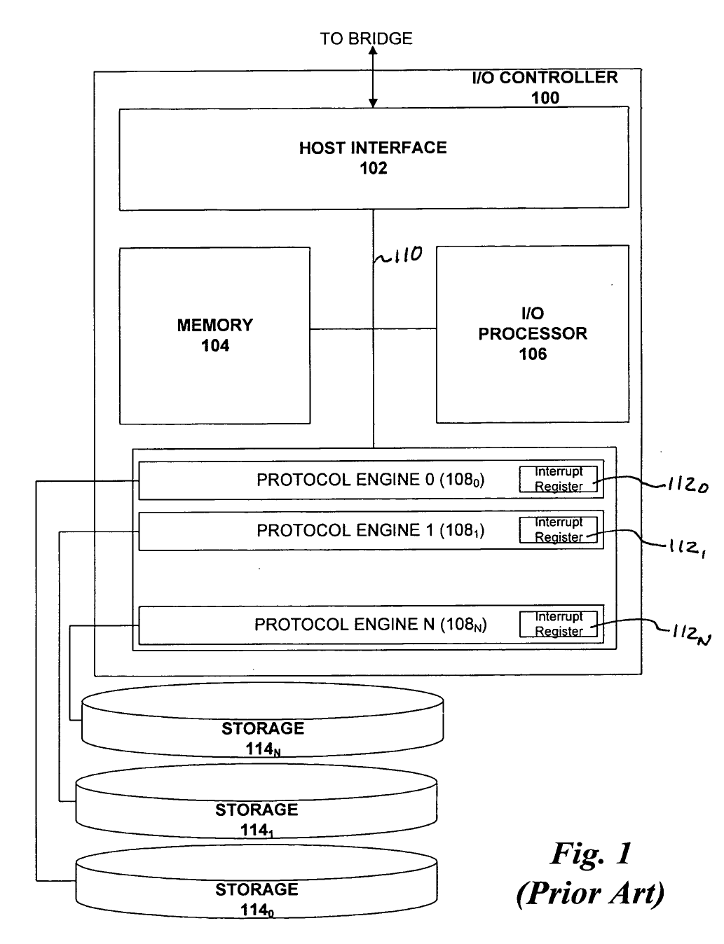

FIG. 2 is a schematic drawing of an embodiment of an input/output (I/O) controller according to the present invention.

FIG. 3 is a schematic drawing of an embodiment of an interrupt handler according to the present invention.

### DETAILED DESCRIPTION OF THE ILLUSTRATED EMBODIMENTS

Embodiments of an apparatus, process and system for efficient processing of interrupts from multiple protocol engines are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail, but nonetheless are within the scope of the present invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

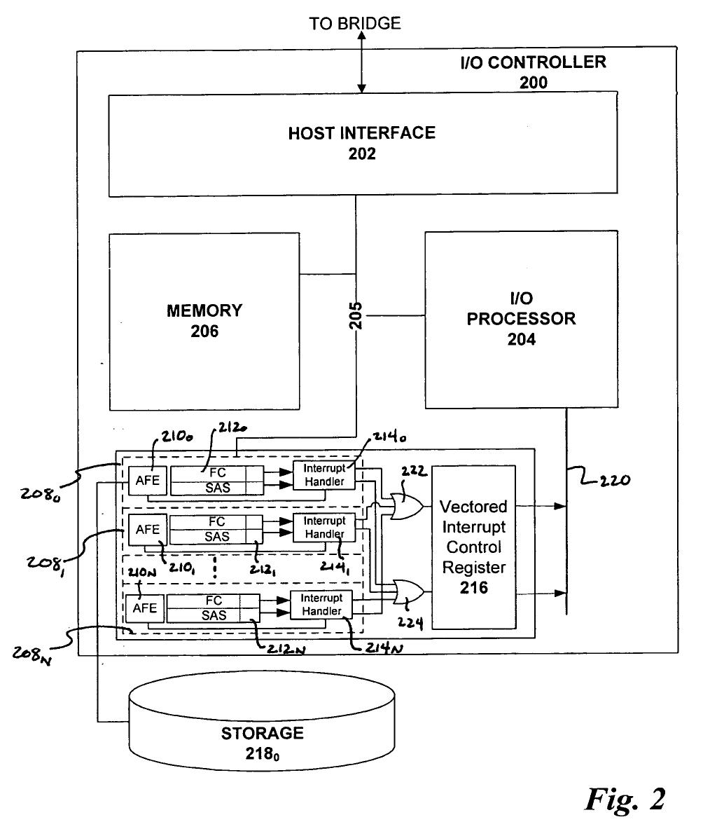

FIG. 2 illustrates an embodiment of an input/output (I/O) controller 200 according to the present invention. The controller 200 includes a host interface 202, a memory 204, an I/O processor 206 and a plurality of protocol engines 208₀ through 208_{N}. The host interface, I/O processor, memory and protocol engines 208₀ through 208_{N} are coupled together by a main bus 205, which the different components of the I/O controller 200 use to communicate with each other. In one embodiment, the main bus 205 can be implemented as a serial bus, but in other embodiments the main bus can have a different implementation, such as a parallel bus or another type of bus. An auxiliary bus 220 directly connects the I/O processor 204 to a vectored interrupt control register 216 that is coupled to the protocol engines 208₀ through 208_{N}. In one embodiment, the auxiliary bus 220 is a higher-performance bus than the main bus 205. For example, where the I/O processor incorporates INTEL XSCALE® technology, the auxiliary bus is a high-speed co-processor bus.

The host interface 202 connects the I/O controller 200 to a bridge through which a host microprocessor of a computer system in which the I/O controller 200 is installed can communicate with various devices. The host interface communicates with the bridge using peripheral component interconnect (PCI) standards such as PCI version 3.0, PCI-X version 2.0 or PCIe version 1.0, all supported by the PCI Special Interest Group (PCI-SIG; please see the PCI SIG website). PCI is a 64-bit bus, though it is usually implemented as a 32-bit bus. It can run at clock speeds of 33 or 66 MHz. At 32 bits and 33 MHz, it yields a throughput rate of 133 MBps. The connection can also used two related standards, both also supported by PCI-SIG: PCI-X 2.0 and PCIe 1.0. PCI-X is short for PCI extended, an enhanced PCI bus that is backward-compatible with existing PCI cards. It improves upon the speed of PCI from 133 MBps to as much as 1 GBps. PCIe is short for PCI Express, an I/O interconnect bus standard (which includes a protocol and a layered architecture) that expands on and doubles the data transfer rates of original PCI. PCIe is a two-way, serial connection that carries data in packets along two pairs of point-to-point data lanes, compared to the single parallel data bus of traditional PCI that routes data at a set rate. In some implementations of PCIe, however, a greater number of pairs of point-to-point data lanes can be used. Initial bit rates for PCIe reach 2.5 Gb/s per lane direction, which equate to data transfer rates of approximately 200 MB/s.

The I/O processor 204 supports the other elements of the I/O controller 200 by performing functions such as interrupt handling, encoding and decoding of serial bit streams coming from and going to the storage device 218, reading and writing data from the memory 206, and so forth. In one embodiment, the I/O processor 204 is a processor incorporating INTEL XSCALE® technology, although in other embodiments other types of processors are possible.

The memory 206 is connected to the processor 204 via the main bus 205. Among other things, the memory 206 stores information or data needed for the operation of the I/O controller 200, as well as data retrieved from the storage device 218 by the I/O controller. In one embodiment, the memory is a synchronous random access memory (SRAM), although in other embodiments the memory may be of a different type or can be comprised of multiple instances having different technology types such as DDRII, SRAM, DRAM, SDRAM and the like. Although shown as one unit in the drawing, in other embodiments the memory 206 can actually include more than one physical unit. Finally, although shown as a unit separate from the I/O processor 204, in other embodiments the memory may be incorporated into the processor or into some other element on the I/O controller 200.

The protocol engines 208₀ through 208_{N} are coupled to the main bus 205. Each protocol engine is also coupled to a corresponding external device such as storage device 218, although only the connection between protocol engine 208₀ and storage device 218₀ is shown in the figure and discussed below for the sake of clarity. In the embodiment shown, each of the protocol engines is the same, meaning that everything shown and discussed in connection with protocol engine 208₀ can apply equally to the other protocol engines. In other embodiments, it is possible that other protocol engines may differ in details such as the particular types of protocols they handle.

In the embodiment shown, the protocol engine 208₀ includes an analog front end (AFE) 210₀ that is directly connected to the storage device 218₀. Among other things, the AFE handles out-of-band (OOB) communication and signaling between the I/O controller 200 and the storage device 218. The AFE also handles other functions such as mediation and speed negotiation between the controller and the storage device 218. During operation, the AFE is a primary source of latency-sensitive interrupts. Interrupts generated by the AFE are also order-sensitive, meaning that the interrupts must be serviced in the order in which they issued. In one embodiment, the interrupts are analog decoded symbols at Gb/s rates, although in other embodiments this may differ.

Attached to the AFE 210₀ is a pair of engines 212₀ including a Fiber Channel (FC) engine and a Serial Attached SCSI (SAS) engine. The pairing of these two engines 212₀ is referred to as a Fiber Channel/SAS Engine (FSENG). SAS is an American National Standards Institute (ANSI) standard protocol that is an evolution of parallel SCSI into a point-to-point serial peripheral interface in which controllers are linked directly to disk drives. SAS is a performance improvement over traditional SCSI because SAS enables multiple devices (up to 128) of different sizes and types to be connected simultaneously with thinner and longer cables; its full-duplex signal transmission supports 3.0 Gb/s. In addition, SAS drives can be hot-plugged. Fiber Channel (FC) is a serial data transfer architecture and protocol developed by a consortium of computer and mass storage device manufacturers and standardized by ANSI. Some implementations of fiber channel support full-duplex data transfer rates of 100 MBps. Fiber channel is compatible with, and is expected to eventually replace, SCSI for high-performance storage systems. In other embodiments, different types of protocol can be used. For example, in an alternative embodiment Serial ATA (SATA) can be used. SATA is also an ANSI standard protocol that is an evolution of the parallel ATA physical storage interface. Serial ATA is a serial link—a single cable with a minimum of four wires creates a point-to-point connection between devices. Transfer rates for SATA begin at 150 MBps.

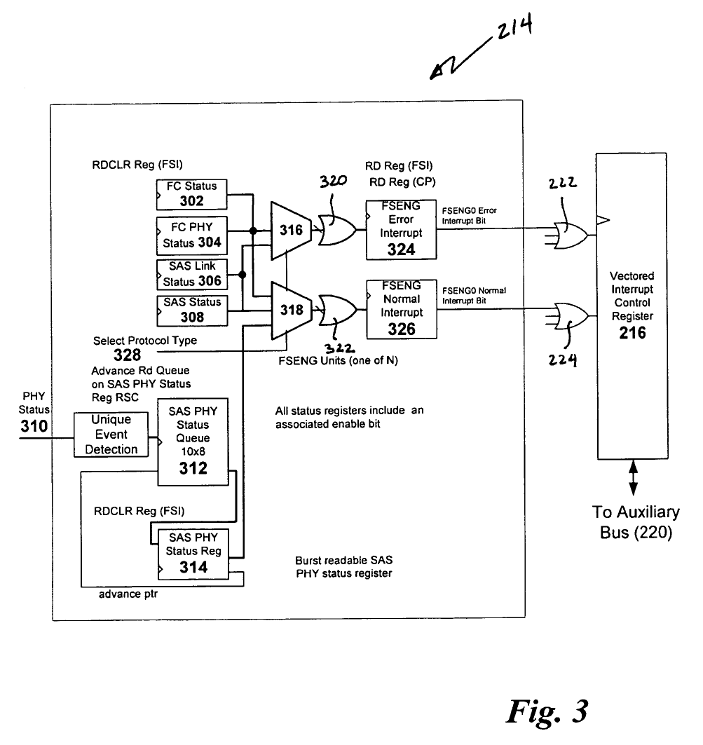

The AFE 210₀ and the fiber channel/SAS engine (FSENG) 212₀ are both coupled to an interrupt handler 214₀. Both the AFE and the FSENG can transmit two types of interrupts to the interrupt handler: normal interrupts, which result from normal system events detected or generated by either the AFE or the FSENG, and error interrupts, which are generated as a result of errors in either the AFE or the FSENG. Interrupts that are received at the interrupt handler 214₀ from the AFE 210₀ and FSENG 212₀ are processed into two interrupt outputs: a normal interrupt output and an error interrupt output. The error interrupts output by each of the interrupt handlers 214₀ through 214_{N} are then coupled to an OR gate 222, the output of which is coupled to a vectored interrupt control register 216. Similarly, the normal interrupts output by each of the interrupt handlers 214₀ through 214_{N} are coupled to an OR gate 224, the output of which is also coupled to the vectored interrupt control register 216. Details of the interrupt handler 214₀ are discussed below in connection with FIG. 3.

The vectored interrupt control register 216 stores information related to each interrupt fed to it from the interrupt handlers 214₀ through 214_{N} and is connected directly to the I/O processor by an auxiliary bus 220. Specifically, for each interrupt generated by an interrupt handler, the vectored interrupt control register 216 stores a “vector” that will tell the I/O processor 204 three things: (1) that an interrupt has occurred, (2) whether the interrupt is a normal interrupt or an error interrupt, and (3) in which protocol engine the interrupt occurred. When the processor 204 reads this information from the vectored interrupt control register 216, the processor 204 can invoke the proper interrupt service routine and service the needs of the relevant protocol engine.

FIG. 3 illustrates an embodiment of an interrupt handler 214 according to the present invention. The interrupt handler 214 includes a pair of status registers 302 and 304 for holding interrupts originating from the Fiber Channel engine as well as a pair of status registers 306 and 308 for holding interrupts originating from the SAS engine. The outputs of each of the status registers 302, 304, 306 and 308 are coupled to a pair of multiplexers 316 and 318. The multiplexer 316 is coupled to the input of an error interrupt register 324 via an OR gate 320, and the output of the error interrupt register 324 is coupled to the vectored interrupt control register 216 via the OR gate 222. Similarly, the multiplexer 318 is coupled to the input of a normal interrupt register 326 via an OR gate 322 and the output of the normal interrupt register 326 is coupled to the vectored interrupt control register 216 via the OR gate 224.

An interrupt status queue 312 has an input 310 that originates from the SAS Phy layer in the analog front end (AFE) 210₀ of the protocol engine 208₀. Attached to the input 310 is some circuitry and logic to detect whether each incoming interrupt is unique; this prevents duplicate interrupts from being written onto the interrupt status queue 312. In the illustrated embodiment, the interrupt status queue 312 is an 8-by-10 queue, meaning that is has eight 10-bit registers. In other embodiments, the interrupt status queue may have registers with larger or smaller bit lengths, may have a different number of registers, or both. The interrupt status queue is a first-in, first-out (FIFO) queue, meaning that the interrupts are input into the queue and read from the queue in the order received.

The output of the interrupt status queue 312 is coupled to the input of an interrupt status register 314 that in one embodiment can be a burst-readable status register. The output of the status register 314 is coupled to the multiplexer 318. A protocol selection input 328 can be used to disable input from the status register 314 to the multiplexer 318, for example for protocols in which interrupts from the AFE are not order-dependent, or for protocols in which the order-dependency is handled in other ways, such as by pre-programmed firmware logic.

In operation of the interrupt handler 214, the status registers 302, 304, 306 and 308 receive interrupts from the Fiber Channel and SAS engines. Each interrupt in the registers is then read and propagated to one of the error interrupt register 324 or the normal interrupt register 326. Each time an interrupt is propagated to the error interrupt register 324 or the normal interrupt register 326, an entry is made in the vectored interrupt control register 216.

At the same time as interrupts from the Fiber Channel and SAS engines is received in registers 302, 304, 306 and 308, interrupts originating in the analog front end (AFE) are input into the interrupt status queue 312. As noted above, interrupts from the AFE 210₀ occur while the protocol engine performs such functions as out-of-band (OOB) communication and signaling or mediation and speed negotiation between the I/O controller 200 and the storage device 218. Interrupts generated by the serial protocol operations are both latency-sensitive and order-sensitive, meaning that these interrupts must be promptly serviced in the order in which they generated. Thus, the interrupts from the input 310 are placed in the interrupt status queue in the order received.

To assure that the interrupts stored in the interrupt status queue 312 are processed in the order received, the status register reads interrupts from the interrupt status queue in the order received; the status queue 312 is thus a first-in, first-out (FIFO) queue. When the status register 314 reads one or more interrupts from registers in the interrupt status queue 312, those one or more registers are cleared and a queue pointer within the interrupt status queue is advanced to the next interrupt to be read in FIFO order. The interrupts read from the interrupt status queue 312 are placed in the interrupt status register 314. When space is available in the normal interrupt register 326, interrupts are read from the status register 314 and propagated to the normal interrupt register 326. The interrupts can be read from the register 314 one at a time or in bursts. Once an interrupt is read from the status register, that interrupt is cleared from the register 314 and a pointer is moved to the next unread interrupt in the register. As interrupts are read and cleared from the status register 314, more interrupts can be read into the status register and cleared from the interrupt status queue 312.

When an interrupt is written into the error interrupt register 324 or the normal interrupt register 326, an entry is made in the vectored interrupt control register 216. The vectored interrupt control register 216 is directly linked to the I/O processor 204 by the auxiliary bus 220, so the I/O processor can read an entry from the vectored interrupt control register 216 and access the relevant interrupt in either the error interrupt register 324 or the normal interrupt register 326. The direct link between the vectored interrupt control register 216 and the I/O processor 204 allows the processor to read and process latency-sensitive interrupts much faster that it could if it had to access interrupt registers in each protocol engine via the main bus 205. The direct link between the vectored interrupt control register 216 and the I/O processor 204 coupled with the use of the interrupt status queue also allows the I/O processor to quickly process order-dependent interrupts in the correct order.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification. Rather, the scope of the invention is to be determined entirely by the following claims, which are to be construed in accordance with established doctrines of claim interpretation.

1. An apparatus comprising:
a plurality of interrupt inputs, a normal interrupt output and an error interrupt output, both interrupt outputs coupled to one or more of the plurality of interrupt inputs;
an interrupt status queue coupled to one of the plurality of interrupt inputs;
a status register coupled to the status queue and to the normal interrupt output;
a normal interrupt register coupled to normal interrupt output; and
a vectored interrupt control register coupled to the normal interrupt register.

2. The apparatus of claim 1 wherein the status register is burst readable.

3. The apparatus of claim 1 wherein the status queue is a first-in, first-out (FIFO) queue.

4. The apparatus of claim 1, wherein the interrupt input coupled to the interrupt queue is also coupled to an analog front end (AFE).

5. The apparatus of claim 4 wherein the interrupts input to the interrupt queue are latency-sensitive interrupts.

6. The apparatus of claim 1, further comprising a control processor coupled to the vectored interrupt control register via an auxiliary bus.

7. The apparatus of claim 1, further comprising an error interrupt register coupled to the error interrupt output.

8. The apparatus of claim 7 wherein the error interrupt register is coupled to the vectored interrupt control register.

9. An apparatus comprising:
a plurality of protocol engines, each having an interrupt handler including:
a plurality of interrupt inputs, a normal interrupt output and an error interrupt output, both interrupt outputs being coupled to one or more of the plurality of interrupt inputs,
an interrupt status queue coupled to one of the plurality of interrupt inputs,
a status register coupled to the status queue and to the normal interrupt output, and
a normal interrupt register coupled to normal interrupt output; and
a vectored interrupt control register coupled to the plurality of normal interrupt registers via an OR gate.

10. The apparatus of claim 9 wherein the status register is burst readable.

11. The apparatus of claim 9 wherein the status queue is a first-in, first-out (FIFO) queue.

12. The apparatus of claim 9, wherein the interrupt input coupled to the interrupt status queue originates from an analog front end (AFE).

13. The apparatus of claim 12 wherein the interrupts input to the interrupt status queue are latency-sensitive interrupts.

14. The apparatus of claim 9, further comprising a control processor coupled to the vectored interrupt control register via an auxiliary bus.

15. A process comprising:
providing protocol engine having an interrupt handler including:
an interrupt status queue coupled to one of a plurality of interrupt inputs,
a status register coupled to the status queue and to the normal interrupt output, and
a normal interrupt register coupled to normal interrupt output;
writing a plurality of interrupts to the interrupt status queue;
reading one or more of the interrupts from the interrupt status queue in first in, first out (FIFO) order and writing the interrupts to the status register;
reading the one or more interrupts from the status register and writing them to the normal interrupt register; and
reading the one or more interrupts from the normal interrupt register and writing them to a vectored interrupt control register.

16. The process of claim 15 wherein writing a plurality of interrupts to the interrupt status queue comprises:
detecting whether each interrupt to be entered in the interrupt status queue duplicates an interrupt already in the queue; and
writing each non-duplicate interrupt received to the interrupt status queue in the order received.

17. The process of claim 15 wherein reading one or more interrupts from the interrupt status queue in FIFO order comprises:
reading one or more interrupts from the interrupt status queue in FIFO order;
clearing the read interrupts from the queue; and
advancing a queue pointer to the next interrupt to be read in FIFO order.

18. The process of claim 15 wherein reading one or more interrupts from the status register comprises:
reading one or more interrupts from the status register;
clearing the read interrupts from the status register; and
advancing a pointer to the next interrupt in the register to be read.

19. The process of claim 15 wherein reading one or more interrupts from the status register comprises burst reading the interrupts.

20. The process of claim 15 wherein writing a plurality of interrupt to the interrupt status queue comprises writing latency-sensitive interrupts to the queue.

21. A system comprising:
a control processor and a memory coupled to each other by a main bus;
a protocol engine coupled to the main bus, the protocol engine having an interrupt handler including:
a plurality of interrupt inputs, a normal interrupt output and an error interrupt output, both interrupt outputs being coupled to one or more of the plurality of interrupt inputs,
an interrupt status queue coupled to one of the plurality of interrupt inputs,
a status register coupled to the interrupt status queue and to the normal interrupt output, and
a normal interrupt register coupled to normal interrupt output;
a vectored interrupt control register coupled to the normal interrupt register; and
an auxiliary bus coupling the vectored interrupt control register to the control processor.

22. The system of claim 21, further comprising at least one additional protocol engine, wherein the normal interrupt registers of the protocol engines are coupled to the vectored interrupt control register via an OR gate.

23. The system of claim 22 wherein the status queue is a first-in, first-out (FIFO) queue.

24. The system of claim 21, wherein the interrupt input coupled to the interrupt queue is also coupled to an analog front end (AFE).

25. The system of claim 24 wherein the interrupts input to the interrupt queue are latency-sensitive interrupts.
